(19) United States
(12) Patent Application Publication
(10) Pub. No.: US 2021/0318125 A1
(43) Pub. Date: Oct. 14, 2021

(54) MILLIMETER-WAVE RADAR-BASED AUTONOMOUS NAVIGATION SYSTEM

(71) Applicant: KING ABDULLAH UNIVERSITY OF SCIENCE AND TECHNOLOGY, Thuwal (SA)

(72) Inventors: Sajid AHMED, Thuwal (SA); Seifallah JARDAK, Thuwal (SA); Mohamed-Slim ALOUINI, Thuwal (SA)

(21) Appl. No.: 17/051,848

(22) PCT Filed: Jun. 11, 2019
(86) PCT No.: PCT/IB2019/054864

§ 371 Date: Oct. 30, 2020

Related U.S. Application Data
(60) Provisional application No. 62/683,133, filed on Jun. 11, 2018.

(51) Int. Cl. G01C 21/34; G01C 21/36; G05D 1/00; G05D 1/02; G01S 13/04; G01S 19/42; G01C 19/00

(52) U.S. Cl. CPC G01C 21/3407; G01C 21/3629; G05D 1/0088; G01C 19/00; G05D 1/0212; G01S 13/04; G01S 19/42; G05D 1/0257

(57) ABSTRACT

A method for autonomous navigating along a given path includes storing at an autonomous navigation system locations associated with a given path; determining a current location of a user; calculating plural positions adjacent to the current location of the user; selecting one position of the plural positions that has a smallest error when compared to the locations associated with the given path; and instructing the user to move to the selected position.

### CROSS-REFERENCE TO RELATED APPLICATIONS

This application claims priority to U.S. Provisional Patent Application No. 62/683,133, filed on Jun. 11, 2018, entitled “NAVIGATOR FOR VISUALLY IMPAIRED PEOPLE,” the disclosure of which is incorporated herein by reference in its entirety.

### BACKGROUND

### Technical Field

Embodiments of the subject matter disclosed herein generally relate to a navigation system, and more particularly, to a system that is capable of autonomous navigation.

### Discussion of the Background

Today there is a great demand for delivering a payload to a given location on Earth, without human intervention. If an object can navigate from one specified point to another specified point intelligently, without or with little input from a human, such navigation can be defined as autonomous navigation. Autonomous navigation can be classified into two categories, aerial autonomous navigation (AAN) and ground autonomous navigation (GAN). The difference between the two is that the first autonomous navigation system is installed on an aircraft or an aerial-unmanned-vehicle (AUV) while the second autonomous navigation system is installed on a terrestrial vehicle or object that moves on the ground.

An AAN system can be very useful in a number of situations. For example, fertilizers and insecticides at different stages of crop development are applied to boost plant growth and protect plants from insect damage, for generating good yields. In developing countries, a farmer typically uses a large spray-truck to apply fertilizers and spray insecticides on the crop. The spray-truck has a small coverage area and thus, the farmer has to pass a field many times until delivering the insecticide or fertilizer to the entire crop. This method is time consuming and spreading of fertilizers and insecticides is not guaranteed to be even, due to which all plants do not grow evenly.

Aerial-autonomous-navigation techniques with low-cost AUVs can be used to evenly apply fertilizers and spray insecticide to plants. This technique can save the farmer from inhaling and exhaling the chemicals distributed to the crop, also prevents portions of the crops and land to be affected due to the movement of the spray-truck.

Modern day AUVs can carry payloads of up to 30 kg and the cost of such AUVs is around USD 10,000. For one acre of agricultural land, the required amount of urea is about 30-40 kg while the amount of insecticide is about 10-15 liters. Therefore, such an AUV can apply fertilizers for an entire acre of land and can spray about 3 acres of agricultural land. The time of delivering this payload per acre can be as low as 5 minutes while a spray-truck takes about 30 minutes.

An AUVs can also be used during natural calamities, such as fire, earthquake, chemically or biologically polluted environments, to help aid workers locate survivors. The AUVs can further be used to deliver food and medicine to survivors trapped at remote locations, due to some natural calamity as the use of a helicopter can be costly and not a very effective solution for food and medicine delivery at a large number of locations.

Ground based autonomous navigation is more complex than AAN due to the presence of a variety of obstacles along the way, such as stationary and moving objects, sinkholes, stairs, and inclined surfaces. GAN technologies have already been implemented to the self-driving cars.

However, experience has shown that all these technologies are using autonomous navigation systems that are not always accurate, which results in accidents or mis-delivery of the payload. Therefore, there is a need to develop a better autonomous navigation system that overcomes these problems and improves the accuracy of the moving object to the desired target.

### BRIEF SUMMARY OF THE INVENTION

According to an embodiment, there is a method for autonomous navigating along a given path. The method includes storing at an autonomous navigation system locations associated with a given path, determining a current location of a user, calculating plural positions adjacent to the current location of the user, selecting one position of the plural positions that has a smallest error when compared to the locations associated with the given path, and instructing the user to move to the selected position.

According to another embodiment, there is an autonomous navigation system that includes a global positioning system configured to obtain locations along a given path and a processing unit connected to the global positioning system. The processing unit is configured to receive a current location of a user from the global positioning system, calculate plural positions adjacent to the current location of the user, select one position of the plural positions that has a smallest error when compared to the locations on the given path, and instruct the user to move to the selected position.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of an autonomous navigation system;

FIG. 2 illustrates an antenna of a mm-wave radar associated with the autonomous navigation system;

FIG. 3 illustrates radar waves propagation between a target and the autonomous navigation system;

FIG. 4 illustrates how the autonomous navigation system calculates future targets for a user of the system;

FIG. 5 illustrates the arrangement of the collected data from the radar for detecting the location of an obstacle in front of the user;

FIG. 6 illustrates recorded data associated with an obstacle that is placed on the ground;

FIG. 7 illustrates a situation when the user is facing a flight of stairs;

FIG. 8 illustrates recorded data associated with the presence of the flight of stairs;

FIG. 9 illustrates a situation when the user is facing a sinkhole in the road;

FIG. 10 illustrates recorded data associated with the presence of the sinkhole;

FIG. 11 illustrates the various functionalities of the autonomous navigation system; and

FIG. 12 is a flowchart of a method for using the autonomous navigation system.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of an autonomous navigation system that is used for visually impaired people (VIP). However, the embodiments to be discussed next are not limited to VIP persons, but they may be used with AUV or ground vehicles that need to move from an initial location to a final target without human intervention.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, an autonomous navigation system includes a mm-wave radar, a global positioning system (GPS), and a gyroscope module. These elements are controlled by a processing unit, which includes an obstacle detection module that is configured to determine moving or non-moving obstacles, stairs, and sinkholes, which are typically encountered by a VIP person. The autonomous navigation system provides navigation instructions to the user using acoustic or haptic feedback, independently from the obstacle detection module. In one embodiment, it is possible to use both acoustic and haptic feedback for interacting with the VIP person.

Such an autonomous navigation system can help VIP people to navigate safely from home to a pre-specified destination. This novel autonomous navigation system could positively impact the life of many VIP people. In this regard, according to World Health Organization (WHO), approximately 285 million people are visually impaired, out of which 39 million are blind and 246 million have low-vision. Increased detectability of obstacles over a wider region and destination guidance can improve their mobility and reduce their dependency on others. The novel autonomous navigation system can be exploited to alert VIP of approaching obstacles, well in advance of arriving at them, and guide them to the desired destination. Such autonomous navigation system can significantly improve the mobility of visually impaired people to perform many everyday activities.

To walk, most of the VIP people use a white cane with which they probe a limited area in front of them. On their way, usually, they cannot detect an obstacle that is hanging above ground and cannot anticipate moving objects approaching them from sides, due to which in many cases, accidents happen. In the developed countries, guide dogs are provided to VIP peoples, but this is a very expensive approach. A relatively low-cost solution is also available, such as UltraCane UK (USD 850) and Phoenix SmartCane India (USD 100). These canes have an electronic device fitted at the top of the cane and the fitted device transmits ultrasonic signals to detect an obstacle and (depending on the distance of the obstacle from the visually impaired person) to generate different buzz signals to warn the VIP about the impeding obstacle. Although the price is low for these devices, the major drawbacks of such canes are (i) their performance depends on the weather conditions, (ii) the handling of the cane is very important, and (iii) they cannot autonomously guide the person to a desired destination.

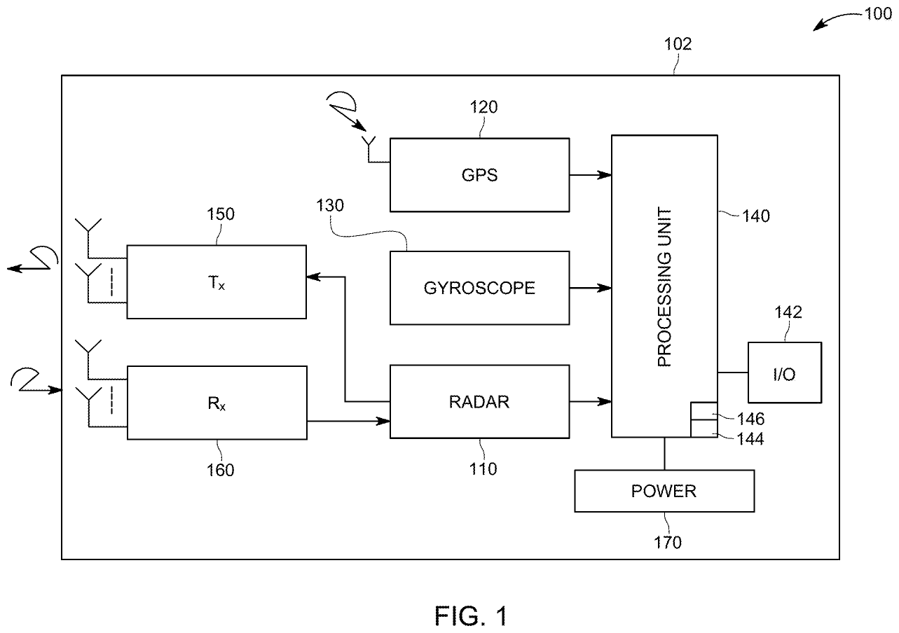

The autonomous navigation system is now discussed with regard to the figures. FIG. 1 illustrates an autonomous navigation system 100 having a radar module 110, a GPS module 120, a gyroscope module 130, a processing unit 140, a transmission module 150, and a receiving module 160. An input/output interface 142 may be connected to the processing unit 140 for providing commands or instructions from a user or trainer to the system. The input/output interface may be configured to have a loudspeaker to provide acoustic (verbal) instructions to its user. A power module 170 may also be present, to supply electrical energy to these modules. The power module 170 may be implemented as a battery, fuel cell, solar cell, or other known power supplies, or even as a combination of these elements. In one embodiment, all the units and modules shown in FIG. 1 can be located inside a housing 102 so that system 100 is unitarily formed and easy to manipulate. The entire system is portable and can be attached to the chest of the user. Each of the modules of the system 100 is now discussed in more detail.

The radar module 110 in this embodiment is chosen to be a millimeter-wave radar. In wireless communication systems, the size of the antenna depends on the wavelength of the transmitted waveform, which is denoted by λ. Usually, the size of the antenna is kept at λ/4. The use of short wavelength waveforms can reduce the size of antenna and as a consequence, the size of the overall system. However, a drawback of using short wavelengths is the high atmospheric attenuation encountered by such waves, which reduces the effective range of the communication device. Another drawback of using short wavelengths is the design of the high-power amplifiers needed to process these waves.

The wavelength of a millimeter-wave (mm-wave) communication device varies from 1 to 10 mm. Therefore, for short-range and low-power applications, the mm-wave can be an ideal choice to miniaturize the size of an electronic device. Further, the use of mm-wave is practical and affordable.

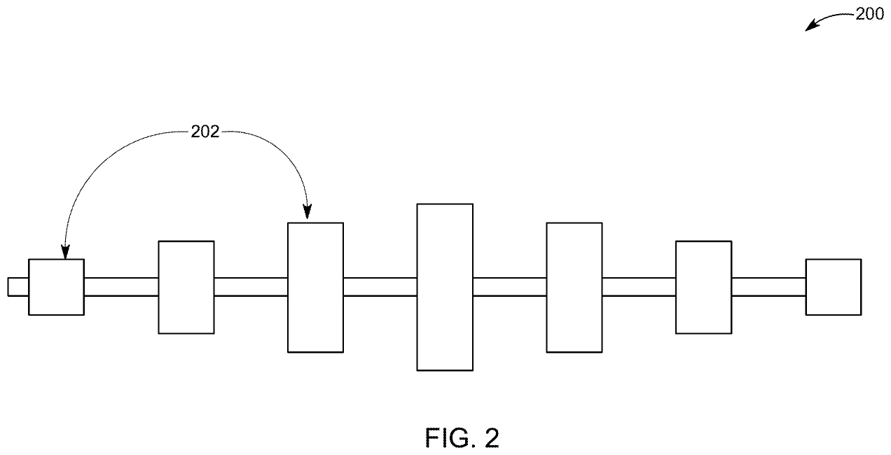

In the novel autonomous navigation system 100, the low-range features of mm-wave and the associated small-size circuitry are exploited to have a small-size radar module 110 for detecting obstacles in the short ranges, which is appropriate for the VIP persons. The radar module 110 is configured to transmit a mm-wave pulse, through the transmission module 150 of duration T and bandwidth B using a directional antenna 200, which can be a series-patch-antenna (SPA) as shown in FIG. 2. The SPA antenna 200 includes plural singular elements 202. The horizontally oriented SPA 200 shown in the figure focuses the transmitted power in the azimuth direction (i.e., horizon), while in the elevation direction, a wide beam-width is achieved. By increasing the number of patches 202 in the SPA antenna 200, the beam-width in the azimuth direction can be further narrowed down and vice-versa.

Similarly, a vertically oriented SPA antenna would focus the transmitted power in the elevation direction. The orientation of the antenna can be selected for the desired coverage region. If the detection of the obstacles is more important in the front top and bottom regions, the transmitted power should be focused in this region. For such applications, the orientation of the SPA antenna should be horizontal. Similarly, the detection of obstacles in the front right and left side require a horizontally oriented SPA antenna.

To find the location of the obstacles, in one embodiment, the signals reflected by a target P are recorded using more than one receive antenna 210. The receive antenna 210 may have a similar configuration as the transmit antenna 200. Generally, the transmit and receive beam patterns of an antenna are the same. The use of receive antennas similar to the transmitter SPA antenna would enable receiving the reflected power mainly from the region where the power was transmitted. In this embodiment, depending on the desired spatial resolution for obstacle detection, two and four receive frequency modulated continuous wave (FMCW) antenna radar IC modules may be used. A minimum of two receive antennas are required to find the elevation angle of the target P, whereas at-least three receiver antennas are required to determine both the elevation and azimuth information of the target P.

For example, the commercially available FMCW radar IC Infineon BGT24MTR12 has one transmit and two receive antennas, and it is a 24 GHz radar with 250 MHz bandwidth. This module can be used with the novel autonomous navigation system of FIG. 1 to detect multiple objects in its path. The various targets can be differentiated by their range (i.e., distance between the navigation system and the target), angle, and Doppler shift. The range resolution of the radar module 110 dependents on the bandwidth of the signal and it can be calculated as ΔR=c/2B, while the spatial resolution depends on the number of receive antennas and the range and it is defined as ΔS=2R/M where M is the number of receive antennas and R is the range. The range resolution of the radar module 110 can be further reduced from 60 cm to 3 cm, using different technologies.

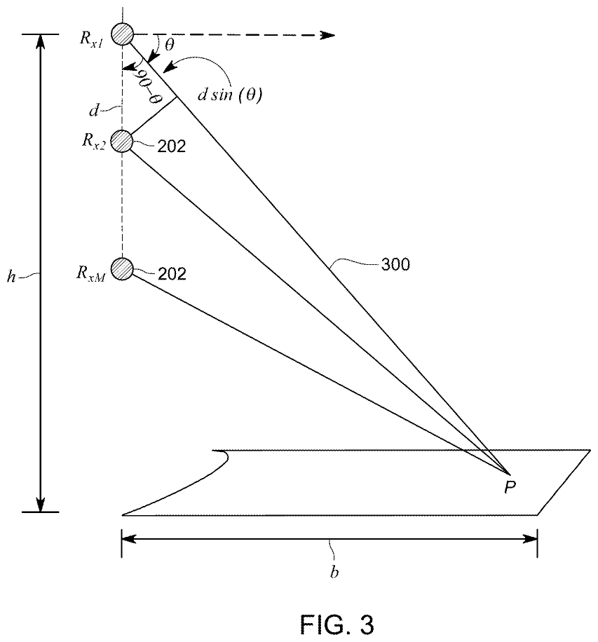

The transmitted pulse from the radar module 100 is coherently repeated with a pulse-repetition-rate Tₚ. The reflected signals 300 from a moving and/or stationary target P are received by antennas Rxi 202 as shown in FIG. 3, where i varies from 1 to an integer M larger than 2. The distance d between any two adjacent antennas 202 is kept at λ/2, where λ is the wavelength of the mm-wave emitted by the antenna. If the distance between the adjacent antennas 202 is increased to be Mλ/2, it will show a single target at M multiple locations. Similarly, reducing the distance between adjacent antennas to λ/2M will increase the spatial resolution. Because the distance d between any two antennas 202 is very small, i.e., in the millimeters range, the received signals 300 at different antennas 202 from any point P, which is placed at a distance b (e.g., a couple of meters), would appear parallel to each other. Note that the serial patch antenna 200 is assumed in FIG. 3 to be at a height h of about 1.5 m. If the point P is at a distance b along the boresight direction X relative to the receive antennas Rxi, the location angle will be considered zero, while for upward and downward locations of the point P, the location angle is considered to be ±θ. The range R and angle of point P can be estimated at the processing unit 140, as discussed later, by processing the received signals at antennas Rxi. These estimated values can then be translated by the processing unit 140 into appropriate commands to be transmitted to the VIP person, for implementing corresponding actions, as will be discussed later.

To design a 2×4 antenna mm-wave FMCW radar module, a combination of ADF5901 (2-Tx) and ADF5904 (4-Rx) ICs can be used. The IC ADF-5904 is configured to demodulate the received signal and provide the in-phase I and quadrature-phase Q analog signals. The I and Q signals from different channels, depending on the number of receive antennas, are amplified using a low-noise amplifier in a first stage and passed through multiple stages of amplifiers/filters, all of which may be part of the radar module 110. The amplified signals from different channels are converted into digital form using ADCs and then passed to the processing module 140. The FMCW radar ICs may include amplifiers, filters, digital converters, and external amplifiers, which can be used for further amplification. All these components are not shown as they are known in the art.

The GPS module 120 is used to find the location of the navigation system 100. To find precisely the location of the user, signals from the local mobile phone's base-stations can also be exploited. The autonomous navigator system 100 works in two modes: training and running. In the training mode, a trainer records the GPS coordinates of the desired final destination and its corresponding path by physically walking from an original place to the final destination, if the system is implemented for a VIP person. If the system is implemented for a drone or other airborne vehicle, the autonomous navigation system 100 is supplied with the start and destination points, and the processing unit 140 is configured to automatically extract the intermediate coordinates from a digital map. In the training mode, the trainer starts walking towards the final destination along a route that is desired by the VIP person. After a pre-defined interval of time, the autonomous navigator system 100 saves the GPS co-ordinates of the current location into a memory. The pre-defined interval of time may be selected by the trainer, and it may be between a couple of seconds to a couple of minutes. When the trainer arrives at the final destination, the trainer may press an END button on the input/output unit 142 of the autonomous navigation system 100, to stop the training mode. At this point, the system saves the coordinates to the final destination and a name can be provided for this specific route. This way, depending on the memory of the system, multiple destinations and associated paths can be stored in the memory.

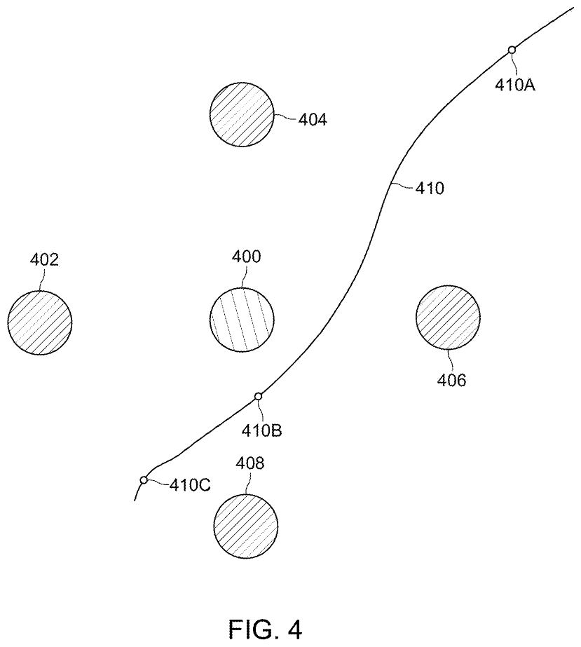

In the running mode, the VIP person chooses a destination by using the input/output interface 142. The autonomous navigation system 100 loads the co-ordinates of the intended destination from the memory (which were recorded during the training mode discussed above) and finds the GPS co-ordinates (latitude, longitude) of the current location using the GPS module 120. Once, the autonomous navigation system 100 has the current GPS coordinates 400 (see FIG. 4), it calculates plural positions 402, 404, 406, and 408 adjacent to the current position 400, by adding or subtracting a unit length from the latitude and longitude coordinates of the current position, depending on the resolution of the GPS signal. For example, the unit length may be a distance less than 1 m or less than 10 m. These adjacent positions can be four locations as shown in FIG. 4. Each location 402, 404, 406, and 408 has one of the latitude and longitude increased or decreased with the given quantity relative to the current position 400. The four locations 402, 404, 406, and 408 are associated with a forward, backward, left or right position relative to the VIP person. In this regard, note that because the VIP person is blind or has a diminished visual acuity, the instructions that he or she receives from the system 100 should be simple to follow, i.e., move forward, move backward, move to the left or move to the right. It is not possible to instruct the VIP person to move 23 degrees north, as the VIP person cannot determine what is 23 degrees to the north. Even a person that has full vision capacity would have a hard time to follow a 23 degrees north command. For this reason, only four directions/positions are used in this embodiment.

Plural actual positions 410A, 410B, 410C, and so on along the path 410 were already recorded during a training mode, and they are stored in a database of the processing unit 140. One of the calculated four positions 402, 404, 406, and 408 would be the target for the VIP in the next step. The position is selected based on a smallest error relative to an actual position (e.g., 410A) along the path 410. One way to implement this selection is to compare each calculated adjacent location 402 to 408 to all of the stored path locations 410A, 4106, etc. and to find the error square. This process will generate four error square vectors, each one corresponding to one of the adjacent locations 402 to 408. Next, the processing unit will find the error square vector having a minimum square-error value. The calculated-adjacent-location corresponding to this vector (e.g., location 404) will be the location of the next step movement for the VIP. In the example shown in FIG. 4, the next target is selected to be the position 404, which means that the system 100 would verbally or haptically or both instruct the VIP person to move forward.

The gyroscope module 130 is configured to calculate the orientation of the autonomous navigation system 100, an implicit orientation of the VIP carrying the system 100 relative to a given reference. For example, the gyroscope module would indicate whether the VIP is facing north or another geographical direction. The orientation of the system is provided to both the radar module 110 and the processing unit 140 so that the system knows the orientation of the VIP when crossing a street. In one application, the gyroscope module 130 is an off-the-shelf unit.

The processing unit 140 of the autonomous navigation system 100 performs the processing and control associated with the previously discussed modules. The processing unit includes at a minimum a processor 144 and a memory 146. More elements may be present in the processing unit. The processing unit 140 is configured to perform a couple of tasks as now discussed.

One task performed by the processing unit 140 is to find the orientation of the autonomous navigation system 100 by reading digital x-, y-, and z-axis co-ordinates from the gyroscope module. The processing unit 140 may be configured to implement various calibrations regarding the orientation of the autonomous navigation system 100. These calibrations would help to calculate the next step in the right direction when the VIP user employs the autonomous navigation system 100. Then, whenever the orientation of the autonomous navigation system 100 changes, the processing unit 140 calculates the calibration and adds the results of the calibration process to the calculations for the next step. An example of a possible calibration is aligning a given direction of the system 100 with a known orientation, like the north pole direction.

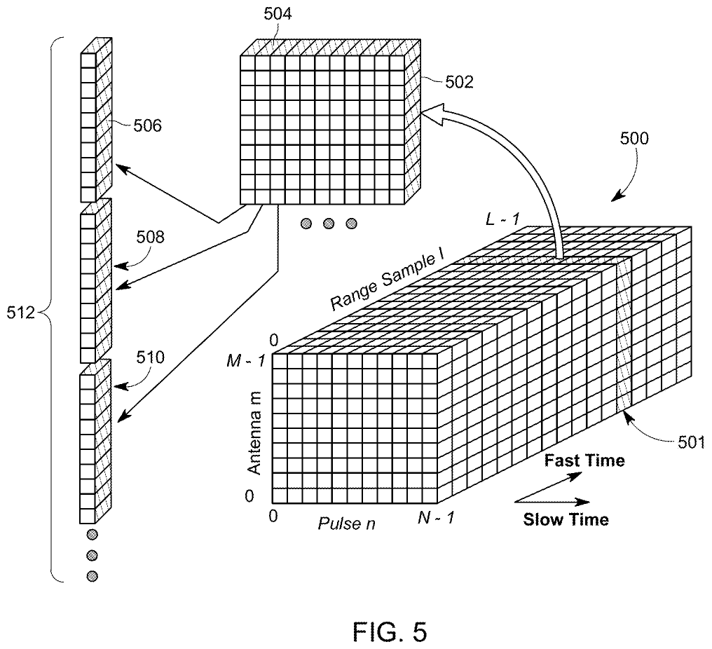

Depending on the sampling frequency, for each transmitted pulse, the processing unit 140 simultaneously reads data samples from multiple receive antennas (channels) and stores them in the memory corresponding to each receive antenna. The collected samples from each receive antenna are called fast-time samples and they are illustrated in FIG. 5. Since there are M receive antennas and L samples are collected from each receive antenna, an M×L matrix can be formed using these samples (fast time samples). Since N pulses are transmitted, collecting samples from multiple receive antennas after each transmitted pulse (slow time samples) can be exploited to form a memory-data-cube (MDC) 500 of dimension N×(M×L), as illustrated in FIG. 5. In the figure, a 2D data matrix snapshot 502 of the MDC 500 is shown. The first row (top row) 504 of this matrix 502 contains the samples from the Mth receive antenna, after each transmitted pulse. If the target is moving, depending on its velocity, the phase of each sample will depend on the velocity of the target in the Ith range bin 501. Note that slice 501 extends in the plane defined by axes Pulse and Antenna in FIG. 5. Applying a discrete Fourier transform (DFT) on this vector 504, a Doppler shift can be calculated for the target in the Ith range bin.

This Doppler frequency is then used to calculate the velocity of the moving target based on equation v=λf_{d}/2, where λ is the wavelength of the light and f_{d} is the frequency of the wave. The first column 506 of the matrix 502 (left side column) contains the samples from M receive antennas after a first pulse for the Ith range bin, the second column 508 of the matrix 502 contains the samples from the M receive antennas after a second pulse for the Ith range bin, the third column 510 of the matrix 502 contains the samples from M receive antennas after a third pulse for the Ith range bin and so on. Vector 512 includes receive samples from the M antennas for each pulse for the Ith range bin. The phases of these samples depend on the location of the target in the Ith range bin. Similar to the previous case, by applying a DFT to this vector, the location angle of the target in this range bin can be determined. Applying two dimensional DFT (2D-DFT) on the overall matrix 500 can determine the locations of all targets present at different locations and corresponding velocity of each target in the Ith range bin. The procedure can then be repeated for all range bins so that all targets can be localized.

If the target P is moving, the phase of the radar reflections from a particular range bin would vary from one pulse to another. By applying a discrete-Fourier-transform (DFT) to slow time samples corresponding to a particular range bin, from any receive antenna, the Doppler shift due to the motion of the target can be found, and thus the moving target can be identified.

Having these capabilities, the processing unit 140 can be used either in the training mode or the running mode. In the training mode, a person other than the VIP person uses the autonomous navigation system device to store the GPS coordinates of a desired path from an initial location A to a final location B. Multiple paths may be stored, and the paths may start from different initial locations and/or may end up at different final locations. The coordinates of each step or every other nth step (n can be any integer larger than one) along the path are stored in the memory. In one implementation, it is possible to receive this information from a map on which a desired path is identified and all the coordinates associated with that path are read from the map into the system. When the person carrying the autonomous navigation system has arrived at the final destination, a command is input to the input/output interface 142 to stop the training mode and/or store the path in the memory. Using the same input/output interface, a name can be associated with this specific path. In the training mode, the processing unit 140 disconnects the radar module 110 from power as the radar module is not used.

The autonomous navigation system can then be activated, through the input/output interface 142 to enter the running mode. Note that the input/output interface 142 may have a microphone and speakers, which are connected to the processing unit 140, so that voice commands may be entered by the VIP person for selecting a desired path, starting guidance of the desired path, and terminating it along the desired path. Of course, voice commands may be implemented for any action to be performed by the VIP person on the autonomous navigation system. At the same time, the processing unit 140 may interact with the VIP person also through voice commands, i.e., the speakers on the input/output interface 142 may ask the VIP person or may direct the VIP person based only on voice instructions. Therefore, when the VIP person is ready to walk to a final destination, the VIP person asks the autonomous navigation system 100 to start navigation to that destination. The autonomous navigation system 100 enters the running mode and the GPS module 120 starts determining the current location of the VIP person. Then, the processing unit 140 compares the four calculated positions, which are associated with the current location of the VIP person, with various locations recorded for the corresponding path by the non-VIP person, and based on a minimum error procedure (see discussion associated with FIGS. 4 and 5), the next step for the VIP person is selected (i.e., move forward, move backward, move left, move right) and then verbally transmitted by the system to the VIP user. If these calculations are performed often, for example, every second, or two seconds, the VIP user can continuously walk due to the updated instructions received from the system.

To be able to verbally instruct the VIP person about a next step, the autonomous navigation system stores in its database an obstacle look-up table of voice messages that are associated with different situations, for alerting the user about an approaching obstacle and/or what type of obstacle. If an obstacle is detected by the system, which is discussed later, the system is configured to deviate the VIP from the last communicated target to another target and then to recalculate the four positions around the current position that avoids the obstacle and is also closer to the measured positions on the given path, so that the VIP user is slowly brought back on the given path.

Similarly, another look-up table may be stored in the database of the processing unit 140 for providing four navigation messages associated with the four calculated positions, for example, (i) move right, (ii) move left, (iii) go straight, and (iv) turn and go straight. Depending on the calculated error based on the GPS module, one of the four messages from the navigation look-up table is played. Both messages (obstacle message and navigation message) are played one-by-one, synchronously. Therefore, the processing unit is configured to also calculate an ID of an appropriate message, depending on the situation, and play that message for the VIP.

However, if the autonomous navigation system 100 is implemented for an AUV, appropriate signals to control the motion of an AUV are calculated and sent to the AUV's controller, for example, fly up, fly down, fly left, etc. In this case, the corresponding signals may be for different motors of the AUV, thus controlling its direction of motion. Similar to the case of the VIP, when the mm-wave radar senses an obstacle, a stop and hover signal can be sent to the controller of the AUV, followed by a fly backward and ascends upwards commands until no obstacle is sensed by the radar module 110. Thus, in this embodiment, in contrast to the conventional AUVs for which the direction of the AUV is controlled from the ground, the on-board processing unit 140 generates appropriate signals to arrive at the programmed final destination, based on information received only from the GPS module, radar module, and the gyroscope module. Note that when the autonomous navigation system 100 is implemented for a vehicle and not a person, the input/output interface 142 is adapted to send appropriate electromagnetic signals to the controller of the vehicle to modify its route and not to emit verbal commands. For these situations, the processing unit may not need to switch to a training mode as the positions of the given path are obtained from an existing electronic map and potential obstacles are determined as the vehicle moves along the desired path. In one application, it is still possible to fly the AUV or drive a GAN to a final destination in a traditional way, i.e., under the supervision of a person from the ground, record the flight data during the training mode, and then ask the AUV to repeat the path based on the data collected during the training and also based on the data collected during the current flight, similar to method discussed above with regard to FIGS. 4 and 5.

Some of the capabilities of the autonomous navigation system 100 are now discussed. The system is configured to detect obstacles (or targets) as already discussed above with regard to FIG. 5. The system can detect moving and non-moving obstacles in front, above, approaching from the left side and approaching from the right side and then the processing unit generates corresponding signals and sends appropriate instructions to the VIP user. As discussed with reference to FIG. 5, by applying 2D-DFT on the angle-Doppler data matrix (front slice of the data cube corresponding to the Ith range-bin 501 in FIG. 5), an angle-Doppler image of the Ith range-bin can be obtained to specify the number of targets and their velocities. Similarly, by applying 2D-DFT on the angle-range matrix (side slice of the data cube corresponding to the pth pulse, i.e., slice that extends in the plane defined by axes Range Sample and Antenna in FIG. 5), an angle-range image after each pulse can be obtained to specify the location and corresponding range of the target.

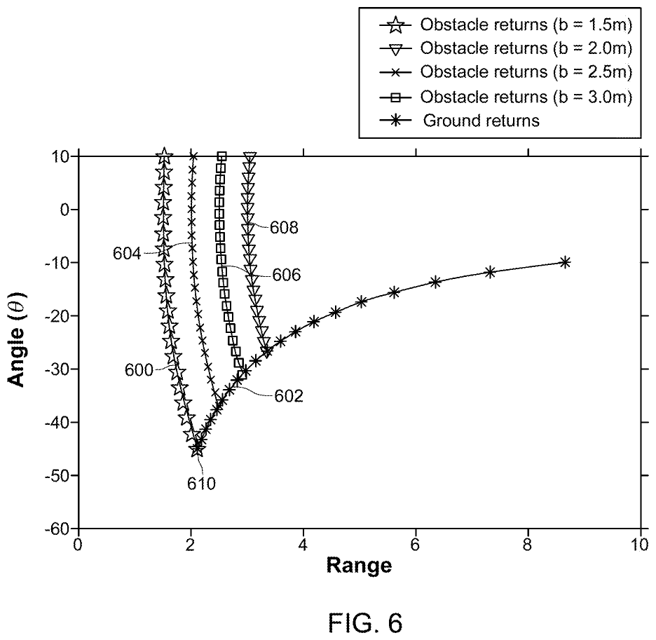

In this regard, FIG. 6 shows the range-angle pattern of an obstacle and associated ground clutter. Anything around angle θ=0 can be considered an obstacle located in front of the VIP. The point 610 where curves 600 and 602 meet represents the foot of the obstacle and also indicates that the obstacle represented by curve 600 is sitting on the ground. If the curve 600 does not meet curve 602, it means that the obstacle does not touch the ground and it is suspended just above the ground. The length of the curve 600 along the angle θ axis represents the height of the obstacle. In other words, on approaching a standing obstacle (i.e., an obstacle that stands on the ground), the autonomous navigation system 100 sees an increase in the angle and a decrease in the range, and thus, the angle-range slope is negative. In the above figure, it is assumed that the VIP is wearing the autonomous navigation system 100 at the height of h=1.5 m and the distance between the foot of the VIP and the base of the obstacle is b=1.5 m for curve 600, b=2.0 m for curve 604, b=2.5 m for curve 606, and b=3.0 m for curve 608. The angle θ and the range R for the curves 602 and 600, which correspond to the ground returns and the obstacle, respectively, are described by the following equations:

$$\begin{matrix}{R}_{g} = \frac{h}{cos ( \frac{π}{2} - θ )} , & ( 1 ) \\ {R}_{o} = \frac{b}{cos ( θ )} . & ( 2 )\end{matrix}$$

By applying the 2D-FFT to the side slice matrix, the location angles of the targets and the corresponding ranges can be found. If there is no obstacle on the way, the system 100 will get multiple peaks at different ranges and the change in angular location with respect to range will not be very abrupt while in the case of the presence of an obstacle, the change will be abrupt. A threshold can be selected and applied to decide whether the change is due to ground reflections or due to an obstacle. To resolve two different obstacles, the distance between two approaching obstacles should be more than c/2B, where c is the speed of light and B is the bandwidth of the transmitted FMCW signal. Based on these characteristics, the processing unit 100 can distinguish between various obstacles.

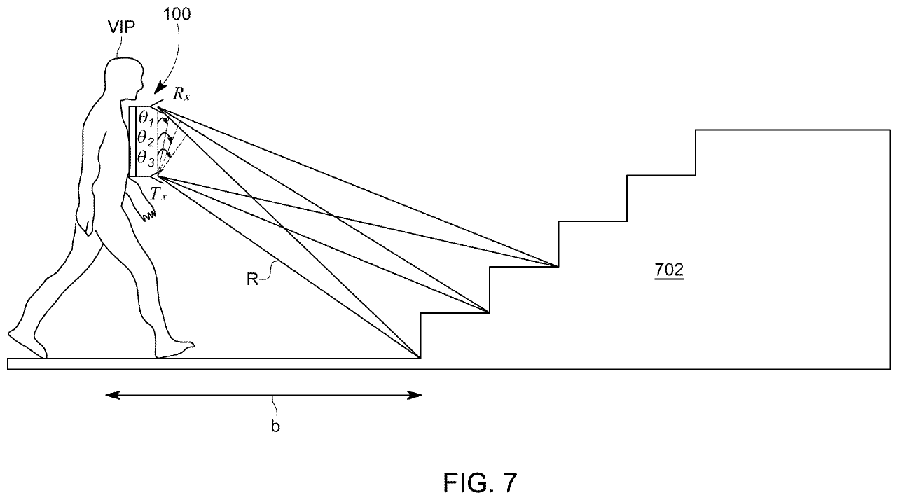

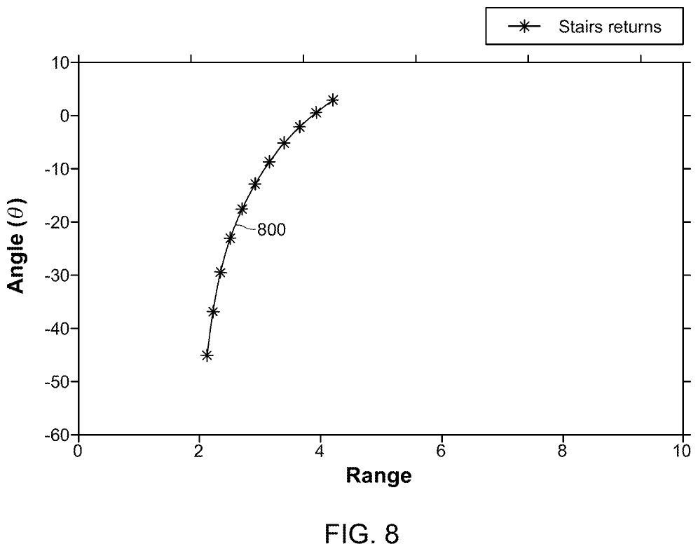

A special type of an obstacle is a flight of stairs, which is quite frequently encountered by a VIP. Thus, this kind of obstacle is treated by the system 100 differently than the ordinary obstacles discussed above with regard to FIG. 6. A flight of stairs signal model for only two receive antennas Rx is shown in FIG. 7. In this figure, it can be observed that as the steps 702 are going up, the range R from the system 100 is slightly increasing, but the angle θ is decreasing. By applying the 2D-DFT transform to the angle-range matrix of the data cube 500 corresponding to the pth pulse, the corresponding angle-range pattern 800 looks as shown in FIG. 8.

In FIG. 7, it is assumed that the VIP person is wearing the system 100 at a height of about h=1.5 m and the distance between the foot of the VIP person and the start of the first stair is about b=1.5 m, while the height of each step of the flight of stairs is hs=0.17 m and the width of each step of the flight of stairs is ws=0.27 m. The range R and angle θ of a stair step “l” is given by the following equations:

$$\begin{matrix}{θ}_{l} = {tan}^{- 1} ( \frac{h - l {h}_{s}}{b + l {w}_{s}} ) , with l = 0 , 1 , 2 , … & ( 3 ) \\ R ( l ) = \frac{h - l {h}_{s}}{cos ( \frac{π}{2} - {θ}_{l} )} . & ( 4 )\end{matrix}$$

Note that the graph shown in FIG. 8 is based on equations (3) and (4). As mentioned above, by applying the 2D-DFT transform to the angle-range matrix, the target location angle and range can be found. A difference between the case when the obstacle is a flight of stairs and the obstacle is a tall obstacle as illustrated in FIG. 6 is that the slope of the angular location with respect to the range is negative for the tall obstacles and positive for the flight of stairs. Based on this differentiation feature, the processing unit 140 can distinguish the presence of the stairs from the presence of a vertical obstacle and inform accordingly the VIP user.

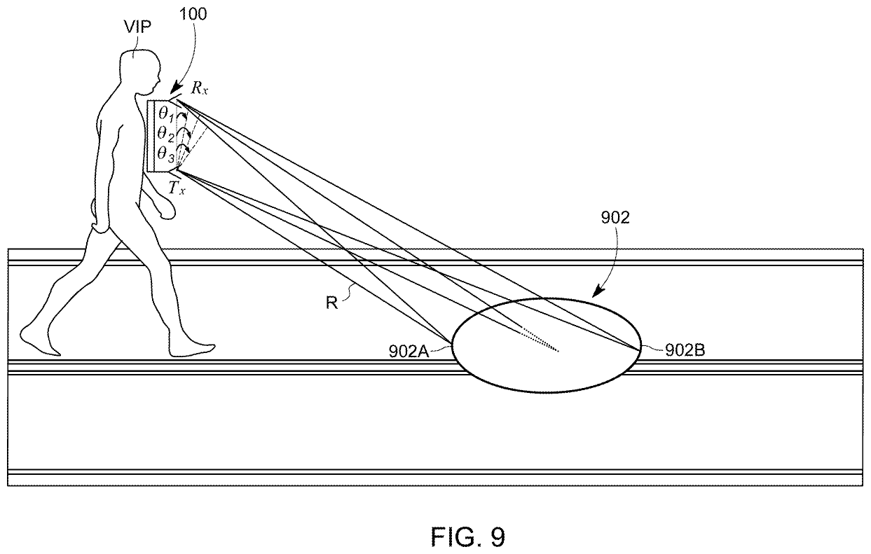

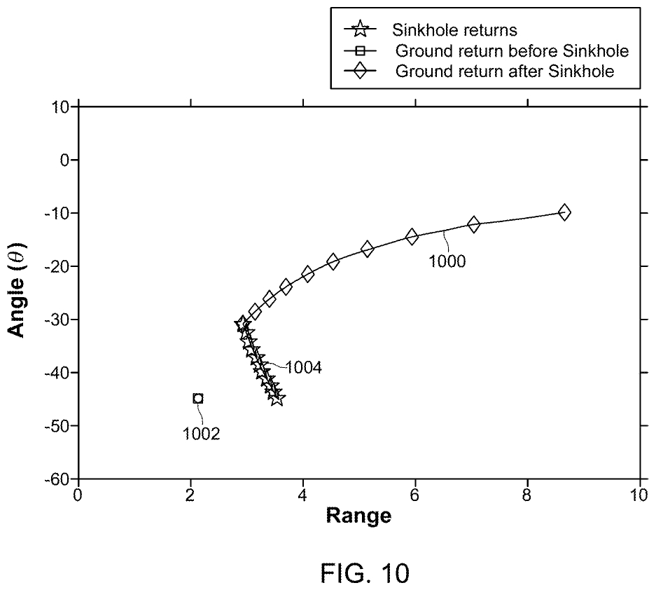

Another type of a special obstacle that needs to be identified as such is a sinkhole. The autonomous navigation system 100 is configured to also detect sinkholes and to inform the VIP person about their presence. The system 100 used by the VIP for detecting sinkholes is illustrated in FIG. 9 and includes at least two antennas, a transmitter module Tx and a receive module Rx, each having one or more antennas. Either of these modules may have the configuration shown in FIG. 2. In the model for the sinkhole, at the start 902A of the sinkhole 902, there is a sudden increase in the range R as the angle θ decreases. Then, at the end 902B of sinkhole 902, the range R increases with the increase in the angle θ. The simulated range-angle pattern of the sinkhole 902 is shown in FIG. 10, with curve 1000 showing the ground return after the sinkhole, curve 1002 showing the ground return before sinkhole, and curve 1004 showing the sinkhole return.

In FIG. 9, it is assumed that the sinkhole 902 is at a distance of about 1.5 m in front of the VIP person and the width of the sinkhole is ws=1 m and the depth of the sinkhole is ds=1 m. The range R and angle θ of a point in the sinkhole are described by the following equations:

$$\begin{matrix}{θ}_{l} = {tan}^{- 1} ( \frac{h + {lh}_{s}}{b + l {w}_{s}} ) , with l = 0 , 1 , 2 , … & ( 5 ) \\ R ( l ) = \frac{h + {ld}_{s}}{cos ( \frac{π}{2} - {θ}_{l} )} . & ( 6 )\end{matrix}$$

Note that at the start of the sinkhole 902, the range R suddenly increases and then decreases slowly with respect to the angle θ. After the sinkhole, the range R starts to increase with respect to the angle θ. For a variety of combinations of stairs, tall objects, and sinkholes, the modelling described by equations (1) to (6) is stored in the system 100 so that the processing unit 140 is able to calculate the corresponding patterns, which are then included into the decision making process for instructing the VIP user about the next move.

The autonomous navigation system 100 works independently from the obstacle detection process, i.e., even if the obstacle detection processing is switched off, the system is still capable to direct the VIP user to its final destination. In other words, while both the navigation and obstacle detection capabilities are implemented in the processing unit 140, one set of capabilities is free to operate independent of the other set of capabilities. However, the system will operate best when both sets of capabilities are available and working together. The system 100 is configured to generate appropriate signals to guide the VIP to pre-stored locations, such as parks, neighboring houses, nearby shopping malls, etc. as now discussed.

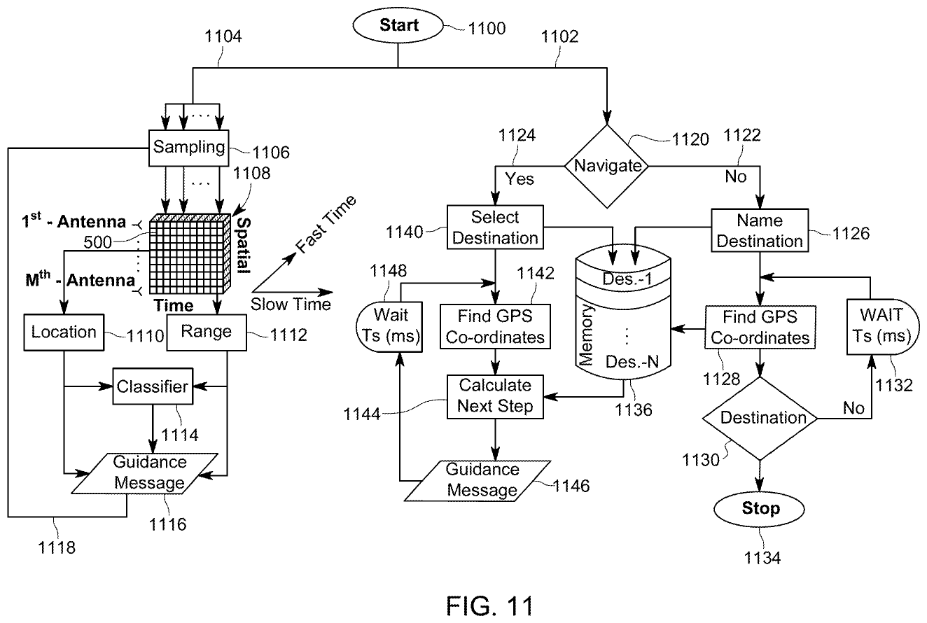

A method for using the autonomous navigation system 100 is now discussed with regard to FIG. 11. In step 1100 the system 100 is initiated (e.g., powered). The system can then be used in the navigation mode or just obstacle detection mode. Thus, the user of the system decides which mode to select. As previously discussed, the user may input a verbal command to the input/output unit 142 to select the navigation mode 1102 or the obstacle detection mode 1104. Suppose that the user has selected the obstacle detection mode 1104. If this is the case, the processing unit 140 initiates the radar module 110 to start sampling in step 1106 the space in front of the VIP user. This means that the radar module 110 is using the transmitter module 150 to send mm-waves and the receiver module 160 to receive the signals reflected due to the generated mm-waves. The received signals are then used in step 1108, as discussed above with regard to FIG. 5, to generate the memory-data-cube (MDC) 500. In step 1110, the location of the obstacles in front of the system 100 are detected and in step 1112 the range of these obstacles is calculated, as discussed above with regard to equations (1) to (6). The calculations for the location and range of one or more obstacles have also been described above with regard to FIG. 5. In step 1114, a classifier may be used to distinguish between a vertical traditional obstacle that stands on the ground, an obstacle that is suspended above the ground, a flight of stairs, or a sinkhole, and to associate a corresponding message from a database 1136 of stored messages with the correct obstacle. Note that as discussed above with regard to FIGS. 6-10, each of these obstacles has a unique signature, i.e., a slope of the angle with the range is different, so that the classifier can distinguish between the various obstacles. In step 1116, the processing unit 140 emits a verbal instruction to the VIP user of the system 100, for example, go straight, or go to the left, or go back, or go to the right, based on the obstacle determined by the classifier. The classifier may be any machine learning classifier, which is based, for example, on probabilities. In step 1118, the method returns to step 1106 and scans again the space in front of the user for detecting obstacles.

If the system 100 is initiated in step 1100 to enter the navigation mode 1102, then the processing unit 140 asks the user in step 1120 to select whether the system should enter a training mode 1122 or a running mode 1124. If the user choses to enter the training mode 1122, then the processing unit 140 asks the user to enter in step 1126 a name to be associated with the path that is used to train the system. After this, in step 1128, the system uses the GPS module 120 to periodically determine the spatial coordinates of the system and record them in the database 1136, which is hosted by the system 100. In step 1130, the processing unit 140 verifies whether the person has arrived at the final destination. If no answer is received from the user, then the system advances to step 1132, where a given time interval is counted and then returns to step 1128 to continue recording various points along the training path. Note that the given time can be anytime between a thousandth of a second to a couple of seconds. In step 1130, if the user inputs a command at the input/output module 142, to the effect that the final destination has been reached, the processing unit 140 stops the guidance operation in step 1134, process the detected GPS coordinates and recording all of them.

However, if in step 1120 the user decides to enter the running mode 1124, then the user is asked in step 1140 to select a destination from those paths that were previously stored in the database 1136. The user selects verbally or by any other means a desired final destination and the GPS module finds in step 1142 the current coordinates of the user. In step 1144, the next position of the user is calculated, as previously discussed with regard to FIG. 4. This step involves error calculations between the four positions generated around the current position of the user and one or more locations along the path selected by the user in step 1140, from the database 1136. After performing these calculations, for example, by mean-square-error estimation, the processing unit 140 selects in step 1146 a guidance message from the database 1136 and informs the VIP user in which direction to proceed, i.e., forward, backward, left, or right. Unless the VIP user has reached the final destination, the method advances to step 1148, where a given amount of time is counted down before finding the new current GPS position of the user in step 1142. This process continues until the final destination is reached.

Note that step 1144 can incorporate the functionality of the obstacle detection mode 1104 so that the processing unit 140 takes into consideration whether an obstacle is present along the way calculated by the system. For example, with regard to FIG. 4, suppose that the user is at current position 400 and the processing unit 140 calculates that the next target position for the user is toward position 404, i.e., move forward. However, the radar module determines that an obstacle is present along the path to the new position 404, for example, a car is blocking a road that needs to be crossed. At this point, the processing unit may wait for a given amount of time and then reuses the radar module to check if the obstacle has cleared. If the obstacle has cleared, the user proceeds toward position 404. If the obstacle did not clear, the processing unit may decide to instruct the user to proceed to a new position 406, which has the second smallest error relative to a point on the actual training path obtained in the training mode 1122. Also, if the obstacle is a flight of stairs, the processing unit may upend the guidance message given to the user, to not only instruct the user to move straight ahead, but also to make the user aware that stairs are in front and need to be climbed.

If the system 100 is provided on an AUV or ground vehicle, instead of training the vehicle along a desired path, coordinates of plural points along the desired path are supplied to the processing unit from an electronic map. It can be seen from the above discussed embodiments that the system 100 is autonomous in the sense that it does not require input from a user after a certain path has been stored in its database, and the system does not require any internet connection to receive additional data while navigating along the given path. Also, the user of the system does not have to input any guiding information after the navigation has started.

Due to the small size of the radar module 110 (all other components of the system are small and light), the system 100 is portable and can be easily carried around by the user, for example on the chest. For ensuring that possible obstacles are detected by the radar module 110, the system 100 may be carried by the user as a backpack, but on frontal region of the user, as illustrated in FIGS. 7 and 9. In this way, the antennas of the radar module are facing forward continuously as the user is not necessarily interested in obstacles that are on the side or behind. Thus, with this configuration, a relative position of the antennas relative to body of the user remains substantially unchanged while the user advances along the given path. For an AUV or another vehicle this is not a concern as the antennas are fixedly attached to the frame of the vehicle.

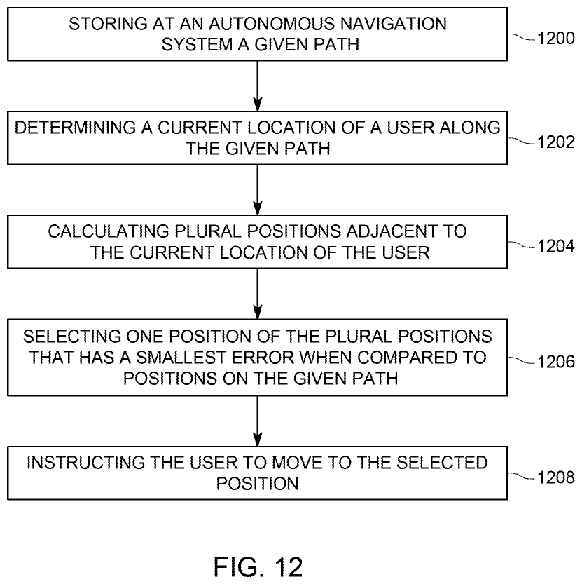

A method for autonomous navigating along a given path is now discussed with regard to FIG. 12. The method includes a step 1200 of storing at an autonomous navigation system, positions associated with a given path, a step 1202 of determining a current location of a user along the given path, a step 1204 of calculating plural positions adjacent to the current location of the user, a step 1206 of selecting one position of the plural positions that has a smallest error when compared to some or all the positions associated with the given path, and a step 1208 of instructing the user to move to the selected position. In one application, the user wears the autonomous navigation system.

The method may further include a step of instructing the user with sound commands to move to the selected position, and/or a step of running the autonomous navigation system along the given path prior to being used by the user, to store the given path. The plural positions are calculated by adding or subtracting a unit length from the coordinates of the current location to obtain four different positions. The four different positions are associated with moving forward, backward, right or left.

The method may further include a step of detecting an obstacle in front of the user with a radar module, which emits wavelengths in the mm range, a step of identifying whether the obstacle is a vertical object on ground, a vertical object hanging above the ground, a flight of stairs, or a sinkhole, and a step of verbally instructing the user about a nature of the obstacle. The method may also include a step of altering the selected location when the obstacle is detected in front of the user. In one application, the autonomous navigation system does not receive any additional information from outside while navigating the given path.

The disclosed embodiments provide an autonomous navigation device that is capable to guide a person or vehicle to a final destination without human intervention and/or connection to internet. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A method for autonomous navigating along a given path, the method comprising:
storing at an autonomous navigation system locations associated with a given path;
determining a current location of a user;
calculating plural positions adjacent to the current location of the user;
selecting one position of the plural positions that has a smallest error when compared to the locations associated with the given path; and
instructing the user to move to the selected position.

2. The method of claim 1, wherein the autonomous navigation system is configured to be worn by the user.

3. The method of claim 1, further comprising:
instructing the user with sound commands or haptic feedback to move to the selected position.

4. The method of claim 1, further comprising:
running the autonomous navigation system along the given path prior to being used by the user, to store the locations associated with the given path.

5. The method of claim 1, wherein the plural positions are calculated by adding or subtracting a unit length from the coordinates of the current location, to obtain four different positions.

6. The method of claim 1, further comprising:
detecting an obstacle in front of the user with a radar module, which emits wavelengths in the mm range.

7. The method of claim 6, further comprising:
identifying whether the obstacle is an object on ground, an object hanging above the ground, a flight of stairs, or a sinkhole; and
verbally instructing the user about a nature of the obstacle.

8. The method of claim 6, further comprising:
changing the selected location when the obstacle is detected in front of the user.

9. The method of claim 1, wherein the autonomous navigation system does not receive any additional information from outside while navigating the given path.

10. An autonomous navigation system comprising:
a global positioning system configured to obtain locations along a given path; and
a processing unit connected to the global positioning system and configured to,
receive a current location of a user from the global positioning system,
calculate plural positions adjacent to the current location of the user,
select one position of the plural positions that has a smallest error when compared to the locations on the given path, and
instruct the user to move to the selected position.

11. The system of claim 10, wherein the autonomous navigation system is portable.

12. The system of claim 10, further comprising:
an input/output interface that transmits sound commands to the user to move to the selected position.

13. The system of claim 10, wherein the plural positions are calculated by adding or subtracting a unit length from coordinates of the current location, to obtain four different positions.

14. The system of claim 10, further comprising:
a mm-wavelength radar configured to detect an obstacle in front of the user.

15. The system of claim 14, wherein the processing unit is further configured to:
identify whether the obstacle is an object attached to ground, an object hanging above the ground, a flight of stairs or a sinkhole; and
verbally instruct the user about a nature of the obstacle.

16. The system of claim 14, wherein the processing unit is further configured to:
change the selected location when the obstacle is detected in front of the user.

17. The system of claim 10, wherein the autonomous navigation system does not receive any additional information from outside while navigating the given path.

18. The system of claim 10, further comprising:
a gyroscope module for determining an orientation of the user.

19. The system of claim 10, wherein the autonomous navigation system is configured to be attached to a chest of the user.

20. The system of claim 19, wherein the autonomous navigation system is configured to guide a blind person along the given path with no need for an additional device.
